(19) United States
(12) Patent Application Publication
(10) Pub. No.: US 2015/0035746 A1
(43) Pub. Date: Feb. 5, 2015

(54) User Interface Device

(71) Applicants: Andy Cockburn, Christchurch (NZ); Mark Billinghurst, Christchurch (NZ); Dinesh Mandalapu, Bangalore (IN)

(72) Inventors: Andy Cockburn, Christchurch (NZ); Mark Billinghurst, Christchurch (NZ); Dinesh Mandalapu, Bangalore (IN)

(21) Appl. No.: 14/369,479

(22) PCT Filed: Dec. 27, 2011
(86) PCT No.: PCT/IN2011/000897

§ 371 Date: Jun. 27, 2014

(51) Int. Cl. G06F 3/01; G06F 3/16; G06F 3/0487; H04N 13/02; G06F 3/0481

(52) U.S. Cl. CPC G06F 3/011; G06F 3/013; H04N 13/02; G06F 3/04815; G06F 3/0487; G06F 3/167
USPC 345/156

(57) ABSTRACT

A user interface device (105) comprising a camera (110, 205) that captures an image of a user's (115) face and fingers (125) and a processor (210, 230) that determines the spatial location of the user's (115) farcical features (120) and fingers (125) using the captured image, in which the processor (210, 230) further determines where on a screen (130) of the user interface device (105) the user (115) is viewing and in which the processor (210, 230) monitors the user's (115) facial features (120) and fingers (125) for indications of manipulation of on-screen content of the user interface device (105).

### BACKGROUND

User interfaces provide a convenience to a user who is accessing information by manipulation of on-screen content. A user may implement, for example, a mouse or trackpad to actuate on-screen content displayed on the user interface. In so doing, the user may manipulate any data associated with the on-screen content. A user may also interact with the user interface via a touch screen device to accomplish similar tasks. However, a user implementing these devices may have difficulties in operating them. For example, a user manipulating on-screen content with his or her finger experiences occlusion or covering up of various objects on the screen while touching the screen. Additionally, it is difficult to select small objects on the screen, especially if the user's fingers are relatively larger than the average user's fingers for which the user interface device is designed for. Still further, there is a limit on what a user may do with an on-screen object due to the binary functionality of either touching or not touching the object being manipulated.

As user interfaces also become more diverse and unique, it further becomes difficult to manipulate or transfer data between them. Indeed, due to the diversity and uniqueness of the various types of user interfaces, a user is left to use or implement multiple types of controls for each user interface. Additionally, the user interfaces may lack support used to manipulate data between them.

### BRIEF DESCRIPTION OF THE DRAWINGS

The accompanying drawings illustrate various examples of the principles described herein and are a part of the specification. The examples do not limit the scope of the claims.

FIG. 1 is a diagram of a user interface system according to one example of the principles described herein.

FIG. 2 is a block diagram of a user interface device according to one example of principles described herein.

FIG. 3 is a flowchart depicting a method of manipulating on-screen content of the user interface device according to one example of principles described herein.

Throughout the drawings, identical reference numbers designate similar, but not necessarily identical, elements.

### DETAILED DESCRIPTION

The present system, product and method disclose a user interface implementing a camera to track the location of a user's eye and fingers relative to the user interface. A user may be allowed to move a cursor across any screen by, for example, holding their index finger and thumb in an open-pinch configuration a distance form the screen of the user interface. The location of the cursor on the screen is determined by a line or vector created by the two spatial points defined by the user's eye and fingers. Therefore, the camera may determine the point in space where the user's eye exists; determine the point in space where the user's finger or fingers exist, and determine or calculate a line or vector created by those two points to determine which location on the screen of the user interface the user is attempting to interact with.

As briefly discussed above, the use of touch screen systems has a number of disadvantages. Specifically, handheld devices such as tablets and smart phones allow users to directly interact with a two-dimensional user interface depicting various on-screen content. A finger, and sometimes a stylus, may be used to manipulate that on-screen content. However, when directly interacting with the surface of the screen on the user interface, the user may cover up or obstruct other on-screen content or manipulatable objects on the screen. This directly affects the user's ability to easily interact with the on-screen content.

Additionally, it may be difficult for a user to precisely select or manipulate objects on the screen of a user interface. This issue may occur when the screen size is relatively small, the objects on the screen are relatively small, if the user's fingers are relatively large, or combinations of these. When this happens, the user interface may not be able to distinguish which, if any, of the objects on the screen are to be manipulated.

Further, a touch screen user interface is binary which may limit the interaction expressivity of the user. Specifically, an object on a touch screen may not be manipulated unless and until the user physically touches the screen. Therefore, the screen may merely sense a selected or unselected on-screen object. This further limits the user's ability to initiate a hover state or temporary selection state of the on-screen content. A desire to have the ability to temporarily select on-screen content on a touch screen has lead to awkward temporal modes being used to determine whether or not a selected object on a user interface has been selected long enough to qualify as a temporarily selected object.

Still further, the use of a touch screen may prove to be undesirable especially if the touch screen is to be used in a public setting. Various people using a single device may lead to the spread of bacteria and viruses. Consequently, this may deter users from touching the touch screen thereby resulting in a decrease in the use of services provided by the touch screen.

User interfaces also come in various forms, some of which may not be completely compatible with each other. The use of many varying types of user interfaces may result in the user implementing a different method of interaction with each user interface. For example, a user may need to actuate a number of push buttons on one device, use a remote control on another device, touch a screen on yet another, and use an external hardware device such as a mouse for another device. This may lead to user confusion and dissatisfaction with using these varying types of input methods. Additionally, the interaction support may not exist to allow users to manipulate data between the various displays. For, example, a user reviewing an image on a mobile device may wish to move the data associated with that image to another device so as to view the image on the other device. Consequently, the first device is communicatively coupled to the other device and the data transferred to the other device. The transfer of such information is usually accomplished via a physical cable between the two devices or through a wireless connection.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language indicates that a particular feature, structure, or characteristic described in connection with that example is included as described, but may not be included in other examples.

In the present specification and in the appended claims, the term “user interface” is meant to be broadly understood broadly as any hardware, or a combination of hardware and software, that enables a user to interact with a system, program, or device. In one example of the present specification, the user interface may comprise a screen. In another example, the user interface may comprise a screen and a camera. In yet another example, the user interface may comprise a screen and a camera integrated into a mobile device such as a tablet computer, a smart phone, a personal digital assistant (PDA), a laptop computer, or a desktop computer, a television, and a printer, among others.

Additionally, in the present specification and in the appended claims, the term “user interface device” is meant to be understood broadly as any device that enables a user to interact with a system, program, or device through any hardware or a combination of hardware and software. In one example, a user interface device may comprise a mobile device such as a tablet computer, a smart phone, a personal digital assistant (PDA), a laptop computer, or a desktop computer, a television, and a printer, among others.

Further, in the present specification and in the appended claims the term “on-screen content” is meant to be understood broadly as any data or symbol representing data that is displayed on a two-dimensional screen associated with a mobile device such as a tablet computer, a smart phone, a personal digital assistant (PDA), a laptop computer, or a desktop computer, a television, and a printer, among others.

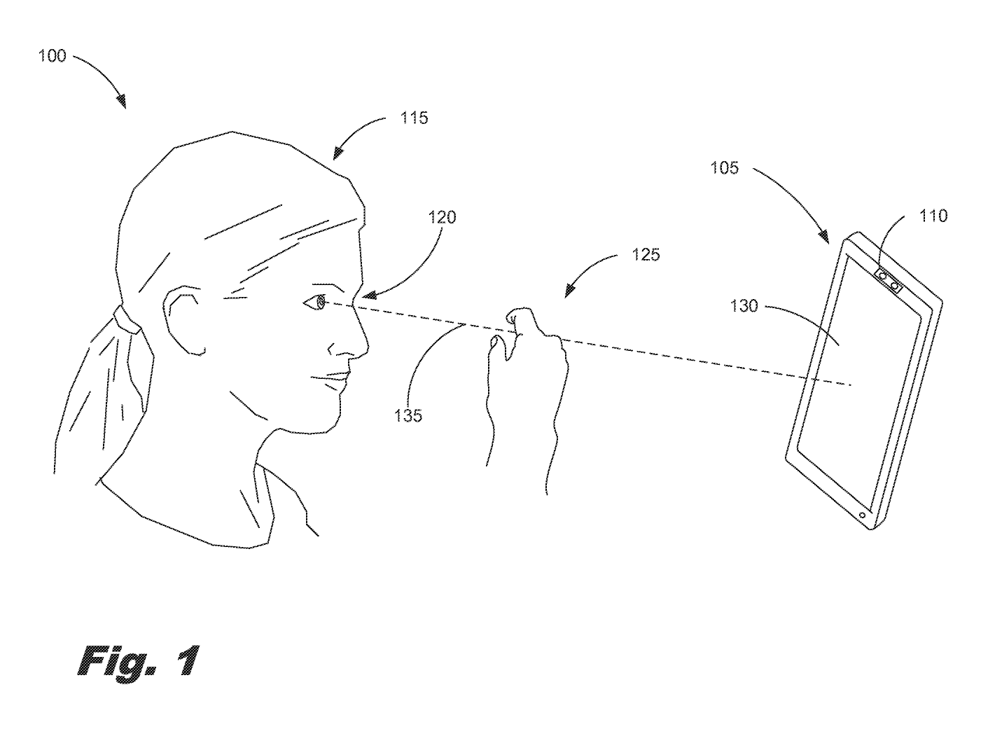

FIG. 1 is a diagram of a user interface system (100) according to one example of the principles described herein. The system (100) may comprise a user interface device (105) and a camera (110). As briefly described above, the user interface system (100) detects the spatial position of a user's (115) eye (120) and fingers (125). The system (100) may then determine the x, y, and z coordinates or spatial position of both the user's (115) facial features or eye (120) and the user's fingers (125). The system may also calculate where on the screen (130) of the user interface device (105) the user (115) is looking at using this information.

As described above, the user interface device (105) may be a tablet computer, a smart phone, a personal digital assistant (PDA), a laptop computer, a desktop computer, a television, and a printer, among others. As will be described later, the user interface device (105) may contain hardware or a combination of hardware and software that accomplishes at least the functionality of determining the spatial position of a user's (115) eye (120) and fingers (125) and determining the position on the screen (130) of the user interface device (105) by calculating a line or vector (135) using the two spatial positions.

The camera (110) may be any type of camera that takes a number of consecutive frames within a certain timeframe. In one example, the camera may have a frame rate of up to 30 frames per second. In another example, the frame rate may be greater than 30 frames per second. In another example, a user (115) may be allowed to adjust the frame rate of the camera (110). This may be done so that the camera (110) may sufficiently determine the spatial position of the user's (115) facial features or eye (120) and fingers (125) while still increasing or decreasing the processing time of the images as they are produced and analyzed.

The camera (110) may further determine the distance of an object relative to the screen (130) of the user interface device (105). In one example, the camera may be a range imaging camera that determines the distance of objects from the camera (110). The images captured by the camera (110) may then be processed to determine the spatial position of the user's (115) eye (120) and fingers (125). Additionally, a processor may be used with the camera (110) to recognize facial features of a human face as well as the user's (115) fingers (125). The camera (110) may further capture images of the user's (115) face with sufficient resolution to determine the position of the user's (115) face, eye socket, eyeball, pupil, or combinations thereof. The resolution of the images may be increased to determine more accurately where on the screen (130) the user (115) is looking.

In one example, the processor may further be used to track the dominant eye (120) of the user and disregard the other eye. In this example, the user may identify his or her dominant eye (120) by entering the information into the user interface device (105).

In one example, the camera is a three-dimensional imaging camera that uses a number of lenses that each capture an image at the same time and combines that image to form a three-dimensional image. From the three-dimensional image, the system (100) may be able to determine the spatial position of the user's (115) eye (120) and fingers (125) and calculate the position on the screen (130) that the user (115) is looking at. As previously discussed, with a frame rate of, for example, about 30 frames per second, the system (100) may determine whether the user (115) is adjusting the distance between his or her fingers (135) a certain distance thereby determining if the user is selecting any on-screen content on the screen (130) of the user interface device (105).

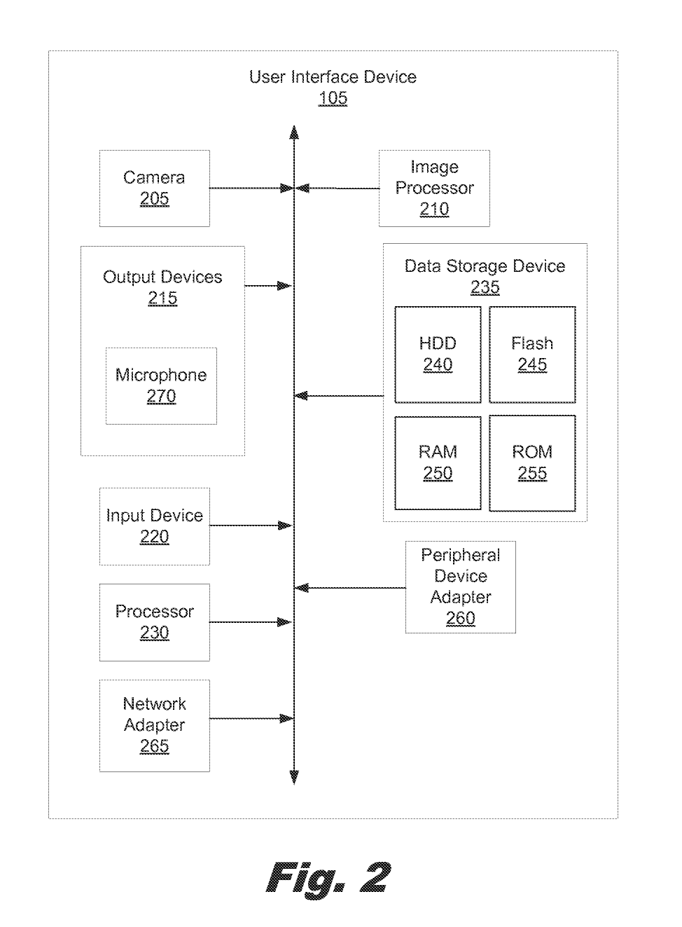

FIG. 2 is a block diagram of a user interface device (105) according to one example of the principles described herein. The user interface device (105) may include hardware or hardware and software that enables a user (FIG. 1, 115) to manipulate objects or data on a screen (FIG. 1, 130) of the user interface device (105). The user interface device (105) may include a camera (205), an image processor (210), a number of output devices (215), an input device (220), a processor (230), and a data storage device (234) which may include Random Access Memory (RAM) (250), Read Only Memory (ROM) (255), Hard Disk Drive (HDD) memory (240), and flash memory (245) among others. Each of these will now be described in more detail.

The camera (205) may be any type of camera that takes a number of consecutive frames in a specific timeframe. The camera (205) may form a part of the user interface device (105) or may be a peripheral device that is communicatively coupled to the user interface device (105) by, for example, a peripheral device adapter (260). As mentioned above, the camera may capture and process a number of sequential images of a user's (FIG. 1, 115) eye (FIG. 1, 120) and fingers (FIG. 1, 125) such that the position of the user's (FIG. 1, 115) eye (FIG. 1, 120) and fingers (FIG. 1, 125) can be determined at a sufficiently high rate. For example, the camera (105) may be capture a number of sequential images of a user's (FIG. 1, 115) eye (FIG. 1, 120) and fingers (FIG. 1, 125) sufficient to determine if the user is moving his or her eye (FIG. 1, 120) and/or fingers (FIG. 1, 125) indicative of the user (FIG. 1, 115) attempting to interact with on-screen content on the screen (FIG. 1, 130) of the user interface device (105). In one example the frame rate may be less than or equal to about 30 frames per second. In another example, the frame rate may exceed 30 frames per second.

The user interface device (105) may also include an image processor (210). The image processor (210) may include hardware architecture that retrieves executable code form a data storage device (235) and executes the executable code. The executable code may, when executed by the image processor (210), cause the image processor (210) to implement at least the functionality of determining the spatial location of a user's (FIG. 1, 115) eye (FIG. 1, 120) and fingers (FIG. 1, 125). The executable code may also, when executed by the image processor (210), cause the image processor to determine a location on the screen (FIG. 1, 130) of the user interface device (105) based upon the spatial locations of the user's (FIG. 1, 115) eye (FIG. 1, 120) and fingers (FIG. 1, 125). The image processor (210) may do this for every frame captured by the camera (205).

The user interface device (105) may further comprise a number of output devices (215). In one example, the output device (215) is a screen (FIG. 1, 130). As described above, the screen (FIG. 130) may graphically represent data that may be manipulated by a user (FIG. 1, 115). The graphical representation of data on the screen (130) may be controlled by a processor (230). The processor (230) may also include hardware architecture that retrieves executable code form the data storage device (235) and executes the executable code. The executable code may, when executed by the processor (230), cause the processor (230) to implement at least the functionality of displaying on-screen content on the screen (FIG. 1, 130).

In another example, the number of output devices may include a device to produce haptic feedback such as a vibratory motor or other actuator, and a speaker, among others. These other output devices (215) may work in cooperation with the screen (FIG. 1, 130) such that visual changes on the screen (FIG. 1, 130) may be felt or heard by the user (FIG. 1, 115).

The user interface device (105) may further include a data storage device (235) and a peripheral device adapter (260). The data storage device (235) may digitally store data received from or produced by a processor (210, 230) associated with the user interface device (105). The data storage device (235) may include Random Access Memory (RAM) (250), Read Only Memory (ROM) (255), flash memory (245), and Hard Disk Drive (HDD) memory (240). Many other types of memory are available, and the present specification contemplates the use of any type of data storage device (235) as may suit a particular application of the principles described herein. In certain examples, different types of memory in the data storage device (235) may be used for different data storage needs.

The peripheral device adapter (260) may provide an interface between the user interface device (105) and the camera (205). The peripheral device adapter (260) may thereby enable the transmission of data related to the captured images to be provided to the user interface device (105) and more specifically to the image processor (210).

An input device (230) may also be included in the user interface device (105). In one example, the user interface device (220) may include input devices (220) such as a microphone, a soft key alpha-numeric keyboard, and a hard key alpha-numeric keyboard, among others.

During operation of the user interface device (105) the user (FIG. 1, 115) may manipulate on-screen content by holding two fingers, such as the index finger and thumb, in an open-pinch position between the user's (FIG. 1, 115) eye (FIG. 1, 120) and the screen (FIG. 1, 130) of the user interface device (105). As described above, the camera (205) may capture a number of successive pictures at a predetermined frame rate and provide those images to an image processor (210). In addition to determining the spatial position of the user's (FIG. 1, 115) eye (FIG. 1, 120) and fingers (FIG. 1, 125) and determining where on the screen (FIG. 1, 130) the user (FIG. 1, 115) is looking, the user interface device (105) may further determine if the user (FIG. 1, 115) is performing an action with his or her fingers indicative of a selection or manipulation of any on-screen content.

In one example, the user (FIG. 1, 115) may close the distance between his or her fingers (FIG. 1, 125) which may be interpreted by the user interface device (105) as a selection of the on-screen content the user is viewing. The user (FIG. 1, 115), after selecting the on-screen content, may then drag the on-screen content to other locations on the screen, off of the screen, into a temporary file such as a recycle bin for data that have been deleted, or further manipulate the on-screen content by opening the file associated with the on-screen content.

In another example, the user (FIG. 1, 115) may, after selecting the on-screen content, drag the on-screen content off of the screen (FIG. 1, 130) creating the allusion that the content is being removed from the user interface device (105). As will be discussed later, the user (FIG. 1, 115) may then drag that information onto the screen of another user interface device.

In yet another example, the user (FIG. 1, 115), after selecting the on-screen content, may bring his or her fingers (FIG. 1, 125) closer or further from the screen (FIG. 130) to further manipulate the selected object. For example, when the user (FIG. 1, 115) brings his or her fingers (FIG. 1, 125) further from the screen (FIG. 1, 130) the selected object may increase in size. Additionally, when the user (FIG. 1, 115) brings his or her fingers (FIG. 1, 125) closer to the screen (FIG. 1, 130) the selected object may decrease in size.

In another example, a single finger (FIG. 1, 125) may be used by the user (FIG. 1, 115) to manipulate on-screen content. In this example, the camera (FIG. 2, 205) may capture an image of the user's (FIG. 1, 115) eye (FIG. 1, 120) and finger (FIG. 1, 125). The processor (FIG. 2, 210, 230) may then determine the spatial position of the user's (FIG. 1, 115) eye (FIG. 1, 120) and finger (FIG. 1, 125) and further determine where on the screen (FIG. 1, 130) the user (FIG. 1, 115) is viewing.

In yet another example, the user (FIG. 1, 115) may use other input devices (220) associated with the user interface device (105) to further manipulate the selected on-screen content. For example, the user (FIG. 1, 115), after selecting the on-screen content, may use a microphone (270) communicatively coupled to the user interface device to, for example, open the selected content by saying the word “open.” Similar actions may be accomplished via this method and the present specification contemplates that use of additional commands to further manipulate the on-screen content.

In still a further example, the user interface device (105), and more specifically, the image processor (210) may detect an eye blink by the user (FIG. 1, 115). The image processor (210), after detecting the eye blink, may interpret the blink as, for example, an item open command and may cause the on-screen content selected by the user (FIG. 1, 115) to be opened. Again, similar actions may be accomplished via this method and the present specification contemplates that use of a blinking eye to represent additional or different commands so as to further manipulate the on-screen content.

As previously mentioned, the user (FIG. 1, 115) may manipulate the on-screen content in such as way so as to transfer or copy the information onto a separate user interface device. The user interface device (105) may therefore be communicatively coupled to another user interface device such that the camera (205) of the first user interface device (105) may track a user's (FIG. 1, 115) eye (FIG. 1, 120) and fingers (FIG. 1, 125) off of the screen (FIG. 1, 130) of the first user interface device (105) and onto that of the second first user interface device. In one example, the second user interface device may also comprise a camera similar to that of the first user interface device (105) to similarly track the user's (FIG. 1, 115) eye (FIG. 1, 120) and fingers (FIG. 1, 125) from the first user interface device (105) over to the second user interface device. Therefore, the user (FIG. 1, 115) may virtually drag on-screen content from one user interface device (105) to another. The processors (210, 230) may be used to coordinate between separate user interface devices to virtually transfer information and data between user interface devices. Additionally, the processors (210, 230) may execute code that causes the first user interface device (105) to send the data associate with the selected on-screen content to the second user interface device via a network adapter (265). Therefore, data may be both virtually and electronically transferred or copied from one user interface device to another.

The user interface device (105) may further allow a user (FIG. 1, 115) to select multiple on-screen objects using any numbers of fingers or sets of fingers. In one example, the user (FIG. 1, 115) may use both sets of thumbs and forefingers on both hands to select a plurality of on-screen objects. Specifically, the camera may capture an image of the user's (FIG. 1, 115) eye (FIG. 1, 120) and fingers (FIG. 1, 125) on both hands and provide that image to the image processor (210). As described above, the image processor may determine the position of the user's (FIG. 1, 115) eye (FIG. 1, 120) and fingers (FIG. 1, 125) on both hands and determine the position on the screen (FIG. 1, 130) the user is viewing. The image processor (210) may determine a first location on the screen (FIG. 1, 130) where the user (FIG. 1, 115) is viewing, determine if the user (FIG. 1, 115) is selecting that on-screen content, and allow that item to be selected. While the on-screen content is selected, the user (FIG. 1, 115) may view other on-screen content and select that content with the other set of fingers (FIG. 1, 125).

In another example, the user interface device (105) may allow a user (FIG. 1, 115) to select multiple objects on the screen (FIG. 1, 130) using a single set of fingers. In one example, similar to that described above, the user (FIG. 1, 115) may use a number of individual fingers to select a number of objects on the screen (130). In this example, the image processor (210) may determine the position of the user's (FIG. 1, 115) eye (FIG. 1, 120) as well as a number of the user's (FIG. 1, 115) fingers (FIG. 1, 125). The user interface device (105) may then detect a selection of on-screen content when the user (FIG. 1, 115) moves a finger forward towards the screen (FIG. 1, 130). In another example, the user (FIG. 1, 115) may use his or her forefinger and thumb in an open-pinch configuration such that a number of on-screen content objects appear to be between the user's (FIG. 1, 115) thumb and forefinger. As described above, the user may then actuate selection of this on-screen content by, for example, blinking or audibly indicating a selection command. In this example, the user (FIG. 1, 115) may increase the size of the selectable area on the screen (FIG. 1, 130) by increasing or decreasing the space between the user's (FIG. 1, 115) thumb and forefinger.

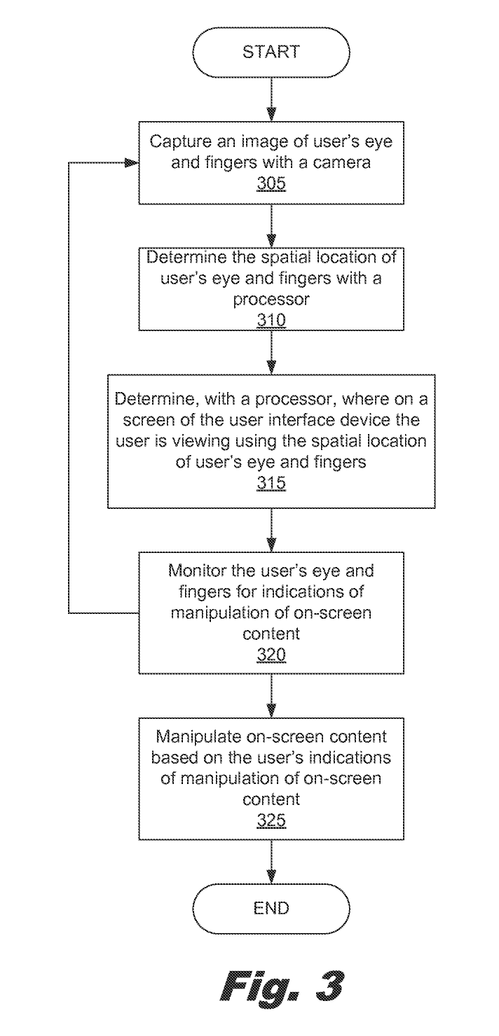

Turning now to FIG. 3, a flowchart depicting a method of manipulating on-screen content of the user interface device according to one example of principles described herein is shown. The method may begin with the camera (FIG. 2, 205) capturing (Block 305) images of a user's (FIG. 1, 115) eye (FIG. 1, 120) and fingers (FIG. 1, 125). As mentioned above, the camera may be a three-dimensional camera and may capture any number of sequential frames per second.

After the camera (FIG. 2, 205) captures (Block 305) an image of the user's (FIG. 1, 115) eye (FIG. 1, 120) and fingers (FIG. 1, 125), an image processor (FIG. 2, 210) may determine (Block 310) the x,y,z spatial location of the user's (FIG. 1, 115) eye (FIG. 1, 120) and fingers (FIG. 1, 125). As discussed above, this may be done by a processor (FIG. 1, 210, 230) executing code such that these spatial locations may be determined (Block 310).

A processor (FIG. 2, 210, 230) may then determine (Block 315) where on a screen (FIG. 1, 130) of the user interface device (FIG. 2, 105) the user (FIG. 1, 115) is viewing. This may be determined using the spatial location of the user's (FIG. 1, 115) eye (FIG. 1, 120) and fingers (FIG. 1, 125) determined (Block 310) earlier.

After it has been determined (Block 315) where on the screen (FIG. 1, 130) the user (FIG. 1, 115) is viewing, the user interface device (FIG. 2, 105) may monitor (Block 320) the user's (FIG. 1, 115) eye (FIG. 1, 120) and fingers (FIG. 1, 125) for indications of manipulation of on-screen content. As described above, the user may manipulate on-screen content in a variety of ways such as by blinking, by saying an audible command, or by increasing or decreasing the distance between his or her finger (FIG. 1, 125).

When the user (FIG. 1, 115) has indicated that on-screen content is to be manipulated, the user interface device (FIG. 2, 105) may manipulate (Block 325) the on-screen content based on those indications. Therefore, the on-screen content will change based on positional changes of the user's (FIG. 1, 115) eye (FIG. 1, 120) and fingers (FIG. 1, 125) as described above.

Throughout the process, the camera (FIG. 2, 205) may continue to capture a number of images a second of the user's (FIG. 1, 115) eye (FIG. 1, 120) and fingers (FIG. 1, 125). Each frame may then be analyzed to determine (Block 310) the spatial locations of the user's (FIG. 1, 115) eye (FIG. 1, 120) and fingers (FIG. 1, 125) as well as to determine (Block 315) where on the screen (FIG. 1, 130) of the user interface device (FIG. 2, 105) the user is viewing. Each image captured (Block 205) may be used to monitor (Block 320) the user's (FIG. 1, 115) eye (FIG. 1, 120) and fingers (FIG. 1, 125) for indications of manipulation of on-screen content.

The methods described above may be accomplished in conjunction with a computer program product comprising a non-transitory computer readable medium having computer usable program code embodied therewith that, when executed by a processor, performs the above processes and methods. Specifically, the computer program product may comprise computer usable program code embodied therein that, when executed by a processor, receives a captured image from a camera (FIG. 1, 110) and determines (FIG. 3, Block 310) the spatial location of a user's (FIG. 1, 115) eye (FIG. 1, 120) and fingers (FIG. 1, 125). The computer program product may further comprise computer usable program code embodied therein that, when executed by a processor, determines (FIG. 3, 315) where on a screen (FIG. 1, 130) of the user interface device (FIG. 1, 105) the user (FIG. 1, 115) is viewing based on the spatial location of the user's (FIG. 1, 115) eye (FIG. 1, 120) and fingers (FIG. 1, 125). The computer program product may still further comprise computer usable program code embodied therein that, when executed by a processor, monitors (FIG. 3, Block 320) the user's (FIG. 1, 115) eye (FIG. 1, 120) and fingers (FIG. 1, 125) for indications of manipulation of on-screen content. The computer program product may even further comprise computer usable program code embodied therein that, when executed by a processor, manipulates (FIG. 3, 325) on-screen content based on the user's (FIG. 1, 115) indications of manipulations of the on-screen content.

The specification and figures describe a user interface device. The user interface device includes a camera and a processor. The processor may receive images from the camera and determine the spatial location of a user's facial features and fingers and determine, using that information, where on the screen the user if viewing on-screen content. This user interface device may have a number of advantages, including manipulation of on-screen content without touching the screen or using a mouse or track pad. Additionally, the user interface device allows a user to drag on-screen content from the screen of the user interface device to another screen of another user interface device. Still further, the user interface device of the present specification allows a user to select on-screen content without obstructing the view of the on-screen content with, for example, a finger.

The preceding description has been presented to illustrate and describe examples of the principles described. This description is not intended to be exhaustive or to limit these principles to any precise form disclosed. Many modifications and variations are possible in light of the above teaching.

What is claimed is:

1. A user interface device (105) comprising:
a camera (110, 205) that captures an image of a user's (115) face and fingers (125); and
a processor (210, 230) that determines the spatial location of the user's (115) facial features (120) and fingers (125) using the captured image;
in which the processor (210, 230) further determines where on a screen (130) of the user interface device (105) the user (115) is viewing; and
in which the processor (210, 230) monitors the user's (115) facial features (120) and fingers (125) for indications of manipulation of on-screen content of the user interface device (105).

2. The user interface device (105) of claim 1, in which the camera (110, 205) is a three-dimensional camera.

3. The user interface device (105) of claim 1, in which the processor (210, 230) determines the spatial location of the user's (115) facial features (120) by determining the location of the user's (115) eye socket, eyeball, pupil, or combinations thereof.

4. The user interface device of claim 1, in which the processor (210, 230) determines where on the screen (130) of the user interface device (105) the user (115) is viewing by calculating a vector consisting of the spatial positions of the user's (115) facial features (120) and fingers (125).

5. The user interface device (105) of claim 1, in which the processor (210, 230) changes the on-screen content of the user interface device (105) when the processor (210, 230) has detected indications of manipulation of on-screen content.

6. The user interface device (105) of claim 1, in which indications of manipulation of on-screen content of the user interface device (105) comprises a blink of the eye (120), an increase in the distance between two of the user's (115) fingers 125), a decrease in the distance between two of the user's (115) fingers (125), an increase in the distance between the user's (115) finger (125) and the screen (130), a decrease in the distance between the user's (115) finger (125) and the screen (130), a change in spatial location of a user's (115) fingers (125), or combinations of these.

7. The user interface device (105) of claim 1, in which the processor (210, 230) further monitors audible cues from the user (115) for indications of manipulation of on-screen content of the user interface device (105).

8. The user interface device (105) of claim 1, in which the camera (110, 205) captures a number of sequential images of a user's (115) facial features (120) and fingers (125) at a frame rate of thirty frames per second or greater.

9. A method of manipulating on-screen content on a user interface device 105), comprising:
capturing an image of the user's (115) eye (120) and fingers (125) with a camera (110, 205);
determining the spatial location of the user's (115) eye (120) and fingers (125) with a processor (210, 230);
determining, with the processor (210, 230), where on a screen (130) of the user interface device (105) the user (115) is viewing using the spatial location of the user's (115) eye (120) and fingers (125);
monitoring the user's (115) eye (120) and fingers (125) for indications of manipulation of on-screen content; and
manipulating the on-screen content based on the user's (115) indications of manipulation of on-screen content.

10. The method of claim 9, in which the camera (110, 205) is a three-dimensional camera.

11. The method of claim 9, in which determining where on the screen of the user interface device (105) the user (105) is viewing is accomplished by calculating a vector consisting of the spatial positions of the user's (115) eye (120) and fingers (125).

12. The method of claim 9, further comprising changing the on-screen content of the user interface device (105) when the processor (210, 230) has detected indications of manipulation of on-screen content.

13. The method of claim 9, in which the processor (210, 230) further monitors audible cues from the user (115) for indications of manipulation of on-screen content of the user interface device (105).

14. A computer program product for manipulating on-screen content on a user interface device (105), the computer program product comprising:
a non-transitory computer usable storage medium (240, 245, 250, 255) having computer usable program code embodied therewith, the computer usable program code comprising:
computer usable program code that determines the spatial location of a user's (115) eye (120) and fingers (125) using an image of the user's (115) facial features (120) and fingers (125) captured by a camera (110, 205),
computer usable program code that determines where on a screen (130) of the user interface device (105) the user (115) is viewing using the spatial location of the user's (115) facial features (120) and fingers (125);
computer usable program code that monitors the user's (115) facial features (120) and fingers (125) for indications of manipulation of on-screen content; and
computer usable program code that manipulates the on-screen content based on the user's (115) indications of manipulation of on-screen content.

15. The computer program product of claim 14, in which the camera (110, 205) is a three-dimensional camera.
